(19) United States
(12) Patent Application Publication
(10) Pub. No.: US 2001/0024589 A1
(43) Pub. Date: Sep. 27, 2001

(54) Printer for forming an image on a transported web

(76) Inventors: Tetsuya Ohba, Hitachinaka (JP); Tsukasa Onose, Hitachinaka (JP); Takeshi Terakado, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/785,284

(22) Filed: Feb. 20, 2001

(30) Foreign Application Priority Data
Mar. 24, 2000 (JP) 2000-83450
Sep. 14, 2000 (JP) 2000-279071

(51) Int. Cl. B41J 11/42

(52) U.S. Cl. 400/582

(57) ABSTRACT

A printer capable of stably transporting a web at high speed and in high accuracy is provided.

The printer comprises a printing unit (10) for forming images on a web (W); a yet-to-be-printed web control means (2, 3, 5) for controlling traveling position and tension of the web at a position upstream in a web transporting direction of the printing unit; and an after-printed web control means (12, 13b, 13c, 13d) for controlling traveling position and tension of the web at a position downstream in the web transporting direction of the printing unit.

### BACKGROUND OF THE INVENTION

The present invention relates to a printer for forming images on a web transported at high speed, and particularly to a printer capable of stably transporting a web at high speed even if the web without feeding perforations is used.

In a printer forming images on a web, in general, the web is transported by engaging pin members of a tractor mechanism mounted on the printer with feeding perforations of the web and driving the tractor mechanism, and at the same time images are formed on the web at an image forming portion of the printer. However, in a case of printing on a web with feeding perforations, cutting-off work for cutting off the perforated portions (usually, both end portions in the width direction of the web) from the web is necessary as the after work, and accordingly it takes an additional time to obtain the final printed matter. Further, the printer is inevitably equipped with the tractor mechanism, which makes the structure of the printer complex. The cutting-off work described above can be eliminated by employing a web without the feeding perforations and by changing the web transporting unit in the printer from the tractor mechanism to a transporting roller mechanism.

In a printer which forms images on a web without feeding perforations while transporting the web using a transporting roller mechanism, if the printer is a printer of a middle speed range up to a speed equivalent to transporting speed of 50 pages/minute on the basis of A4-size paper in landscape configuration, slip does not occur between the web and the transporting roller so much, and printing with little misalignment of position can be performed.

However, in a printer of a high speed range having a printing speed above 100 pages/minute or in a printer of an ultra-high speed range having a printing speed above 200 pages/minute, the conventional structure is difficult to correctly transport the web to the printing portion. Therefore, it is necessary to highly accurately control tension and traveling position of the web during transporting the web.

### SUMMARY OF THE INVENTION

An object of the present invention is to provide a printer capable of stably transporting a web at high speed and in high accuracy.

The above object can be attained by a printer for forming an image on a transported web, which comprises a printing unit for forming the image on the web; a yet-to-be-printed web control means for controlling a traveling position and a tension of the web at a position upstream in a web transporting direction of the printing unit; and an after-printed web control means for controlling a traveling position and a tension of the web at a position downstream in the web transporting direction of the printing unit.

### BRIEF DESCRIPTION OF DRAWINGS

FIG. 1 is a view showing the overall structure of an embodiment of a printer in accordance with the present invention.

FIG. 2 is a schematic side view showing an example of a guide means used in the printer in accordance with the present invention.

FIG. 3 is a schematic front view showing the example of the guide means used in the printer in accordance with the present invention.

FIG. 4 is a schematic perspective view showing an example of an edge detection means used in the printer in accordance with the present invention.

### DESCRIPTION OF THE PREFERRED EMBODIMENTS

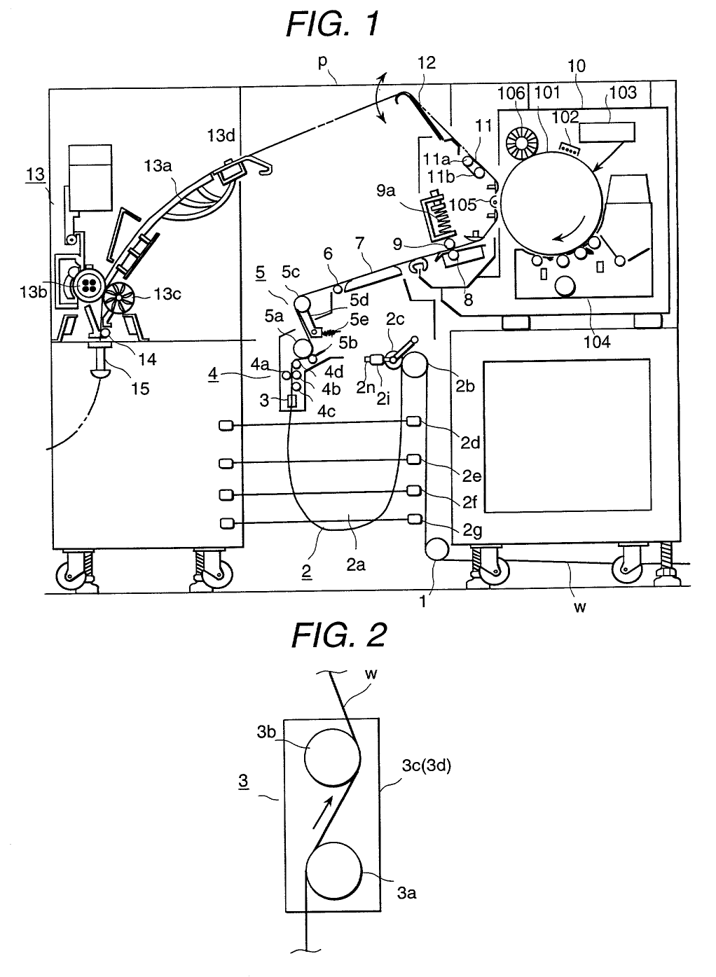

An embodiment of the present invention will be described below, referring to the accompanied drawings. FIG. 1 is a schematic view showing an embodiment of a printer in accordance with the present invention.

In FIG. 1, the reference character W is a web. In the printer, the web W is usually made of paper in most cases, but it is not limited to paper. In some cases, the web is a plastic film. The web is sent out from a feeder (not shown), and passes under a printer P to be sent into the printer P.

The web W sent into the printer P is guided by a guide roller 1 arranged on the transporting path to be transported toward a web buffer mechanism 2. Therein, the guide roller 1 does not have any driving mechanism, but is a driven roller which is rotated by contacting with the transported web W.

The web buffer mechanism 2 comprises an accumulation part 2a for temporarily accumulating the transported web W; a pair of rollers 2b, 2c arranged an upstream portion in the web transporting direction to the accumulation part 2a; and a plurality of sensors (in this embodiment, four pairs of optical sensors 2d, 2e, 2f, 2g are used) for monitoring a slack amount (a buffer amount) of the web in the accumulation part 2a. Therein, the roller 2b is a driving roller having a drive mechanism (not shown), and the roller 2c is a driven roller not having any drive mechanism. Further, the roller 2c is equipped with a control mechanism for controlling a pressing force against the roller 2b. In the control mechanism in the present embodiment, a weight 2i is slidably arranged in a shaft 2h projecting from one end of the roller 2c, and the pressing force of the roller c against the roller 2b is controlled by changing the position of the weight 2i, that is, by using the principle of leverage.

In the accumulation part 2a, the buffer amount is always monitored so that the bottom face of the slacked web W is kept at the level of the sensor 2f. When the bottom face of the web W comes to the level of the sensor 2g, as shown in the figure, the rotation of the roller 2b is controlled to be slowed down so that the bottom face of the web W may be raised up to the level of the sensor 2f. On the contrary, when the bottom face of the web W comes to the level of the sensor 2e, the rotation of the roller 2b is controlled to be speeded up so that the bottom face of the web W may be lowered down to the level of the sensor 2f. Even if the rotation control of the roller 2b described above is performed, there are some cases where the web W can not be returned to the level of the sensor 2f due to wearing of the roller 2b or the roller 2c, or erroneous control of the pressing force. Particularly, when the buffer amount is in the tendency of decreasing, the tension of the web is increasing to cause rupture of the web being transported. In order to prevent such an event, when the bottom face of the web W reaches the level of the sensor 2d, transportation of the web is forced to be stopped.

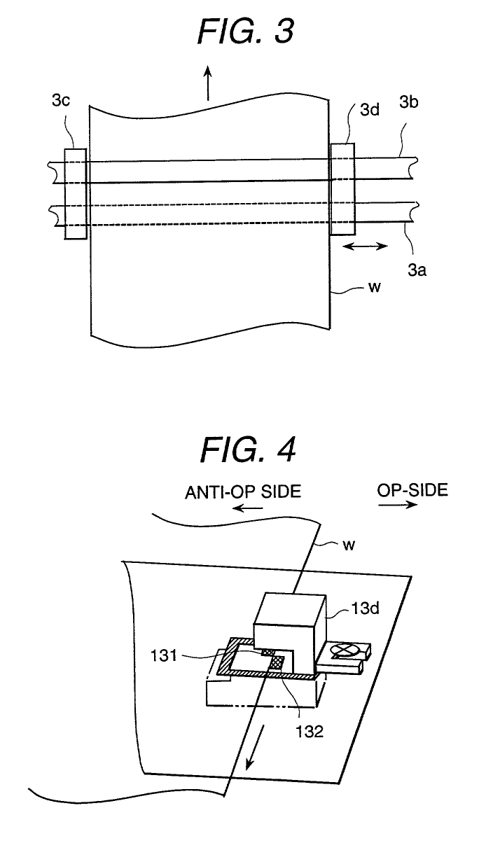

A guide member 3 for restricting the edge position of the web W being transported is arranged in the web sending-out portion of the accumulation part 2a. The guide member 3 has two fixed shafts 3a, 3b, and the web W passing through the guide member 3 is transported by passing between the shaft 3a and the shaft 3b, as shown in FIG. 2. Restricting members 3c, 3d for restricting the positions in the width direction (the direction perpendicular to the transporting direction) of the web W being transported are arranged in the two shafts 3a, 3b. Therein, it is preferable that both of or one of the restricting members 3c, 3d is arranged movably along the axial direction of the shafts 3a, 3b. That is, making the restricting members 3c, 3d movable means that size of the web used in the printer is not limited and accordingly the printer can used various kinds of webs. In the present embodiment, as shown in FIG. 3, the restricting member 3c is arranged so as to be fixed at a constant position, and the restricting member 3d is moved corresponding to the width of the web W. Since the guide member 3 acts to the web W in the slack state at the accumulation part 2a, as described above, the traveling position of the web W coming in contact with the guide member 3 can be easily corrected.

Next, the web W passed through the guide member 3 is sent into an extraneous substance removing mechanism 4. The extraneous substance removing mechanism 4 has a pair of fixed shafts 4a, 4b, and fixed shafts 4c, 4d arranged at positions before and after the shafts 4a, 4b. Therein, the shaft 4a and the shaft 4b are arranged so as to form a predetermined very narrow gap between them. There are some cases where extraneous substances such as paper powder, dust and the like are attached on the transported web W. If the web W having a nodule of extraneous substance is sent into the printing unit, the structural parts of the printing unit (for example, a photosensitive body) may be damaged. The narrow gap is provided to prevent such extraneous substances from entering into the printing unit. Therefore, for example, when an extraneous substance is firmly attached onto the web surface and the extraneous substance can not be peeled off from the web surface even passing through the narrow gap, the web W is broken off at that position to prevent the structural parts of the printing unit from being damaged. The narrow gap in the present embodiment is set to about 0.5 mm, but the dimension is not limited to this value, and may be set to an appropriate value depending on a thickness of the web used or the shape and structure of the transporting path. The shaft 4c and the shaft 4d arranged at the positions before and after the shafts 4a, 4b serve as guide members for guiding the web W to the narrow gap.

After passed through the extraneous substance removing mechanism 4, the web W is sent into a tension adding mechanism 5. The tension adding mechanism 5 is composed of a drum 5a without any driving mechanism; a roller 5b arranged so as to be pressed to the drum 5a; and a drum 5c movably supported on the web transporting path. Therein, the drum 5a may be a fixed drum, or may be a driven drum driven by contacting with the web W being transported. The roller 5b pressed to the drum 5a is provided as a driven roller, and the roller in this embodiment has a structure that the roller is composed of a plurality of sections divided in the width direction of the web W. The drum 5c is fixed to a free end of a movably supported arm 5d, and pressed to the surface of the web W using a spring 5e. By providing the tension adding mechanism 5, tension of the web W can be maintained constant.

The web W passed through the tension adding mechanism 5 is sent into the printing unit 10 by transporting rollers 8, 9 through a guide shaft 6 and a guide plate 7.

In the printing unit 10, for example, a printer of an electrophotgraphic recording type is used. When a photosensitive drum 101 explained with an example of an image holding body is started to be rotated, a high voltage is applied to a corona charger 102 to uniformly charge the surface of the photosensitive drum 101. Light output from a light source 103 composed of a semiconductor laser or a light emitting diode image-exposes on the photosensitive drum 101 to form an electrostatic latent image on the photosensitive drum 101. When the area of the photosensitive drum 101 holding the electrostatic latent image reaches a position opposite to a developing unit 104, a developing agent is supplied to the electrostatic latent image to form a toner image on the photosensitive drum 101. The toner image formed on the photosensitive drum 101 is attracted onto the web W by an action of transfer unit 105 which adds charge having the inverse polarity to the toner image onto the back side surface of the web W. The area passed through the transfer position of the photosensitive drum 101 is cleaned by a cleaning unit 106 to ready for the next printing operation.

The web W having the toner image transferred from the printing unit 10 in the manner as described above is transported to the after stage by a transporting belt 11. Therein, in regard to transporting rollers 8 and 9, the transporting roller 8 is a driving roller having a driving mechanism, and the transporting roller 9 is a driven roller pressed to the transporting roller 8 through the web W by an elastic force of a spring 9a. Further, the transporting belt 11 is stretched between and supported by a driving roller 11a and a driven roller 11b, and has a sucking unit (not shown) to transport the web W by sticking the back surface of the web W on the transporting belt 11.

The web W sent out from the transporting belt 11 is transported to a fixing unit 13 through a buffer plate 12. The web W arriving at the fixing unit 13 is pre-heated by a pre-heater 13a, and then is transported by a nip part formed of a pair of fixing rollers composed of a heating roller 13b and a pressing roller 13c to melt and fix the toner image on the web W.

The web W sent out by the heating roller 13b and the pressing roller 13c passes through a sending roller 14, and is alternately folded by pendulum action of swing fin 15 to be stacked inside the printer P, or is taken out of the printer P as shown by the break line to be performed with appropriate processes such as cutting, stapling, punching and so on in an after-processing unit (not shown). Thus, the series of work is completed.

In FIG. 1, the above-mentioned buffer plate 12 is for absorbing slack or tension produced in the web W when a transporting speed difference occurs between the transporting belt 11 and the fixing rollers 13b, 13c. When the buffer plate 12 is tilted toward the upper side from a preset neutral position of the buffer plate 12, the heating roller 13b is controlled to be rotated at a higher speed so that the buffer plate 12 may be moved down to the neutral position. On the contrary, when the buffer plate 12 is tilted toward the lower side from the neutral position, the heating roller 13b is controlled to be rotated at a slower speed so that the buffer plate 12 may be moved up to the neutral position. As described above, the control system is constructed so that a constant tension is applied to the web W.

The reference character 13d indicates a sensor for detecting meandering of the web W. In the printer of the present embodiment, the web having no feeding perforations in the both end portions in the web width direction is used. Therefore, the sensor 13d detects an amount of meandering based on the edge position of the web, as shown in FIG. 4. For example, the sensor 13d has shading amount detection portions 131 and 132 at positions on the both edge boundaries of the web W in the printer front side (hereinafter, referred to as “OP side”) and in the printer rear side (hereinafter, referred to as “anti-OP side”), respectively. In each of the shading amount detection portions 131, 132, an LED and a photo-diode (outputting linear voltage corresponding to an amount of received light) are arranged opposite to each other, and a position of the web W existing between them is detected from the shading light amount. The traveling position of the web W in a meandering state is corrected by varying pressing forces in one side and in the other side of the pressing roller 13c to the heating roller 13b corresponding to the output from the sensor 13d.

As having been described above, since the printer in accordance with the present invention comprises the yet-to-be-printed web control means for controlling the traveling position and the tension of the web at the position upstream in a web transporting direction of the printing unit; and the after-printed web control means for controlling the traveling position and the tension of the web at the position downstream in the web transporting direction of the printing unit, the web can be stably transported at high speed and in high accuracy, and a good image without blur can be formed on the web.

What is claimed is:

1. A printer for forming an image on a transported web, which comprises:
a printing unit for forming the image on said web;
a yet-to-be-printed web control means for controlling a traveling position and a tension of the web at a position upstream in a web transporting direction of said printing unit; and
an after-printed web control means for controlling a traveling position and a tension of the web at a position downstream in the web transporting direction of said printing unit.

2. A printer for forming an image on a transported web without feeding perforations, which comprises:
a printing unit for forming the image on said web;
a yet-to-be-printed web control means for controlling a traveling position and a tension of the web at a position upstream in a web transporting direction of said printing unit; and
an after-printed web control means for controlling a traveling position and a tension of the web at a position downstream in the web transporting direction of said printing unit.

3. A printer for forming an image on a transported web, which comprises:
a printing unit for forming the image on said web;
an accumulation part for giving slack to said web, said accumulation part being arranged at a position upstream in a web transporting direction of said printing unit;
a web buffer means having a slack amount detection means for detecting an amount of slack of said web in said accumulation part and a bringing-in means for bringing said web into said accumulation part;
a tension adding means for adding a tension to said web, said tension adding means being arranged between said printing unit and said web buffer means;
a guide means for moving said web in a direction perpendicular to the web transporting direction before introducing said web into said tension adding means to correct a traveling position of said web;
a first transporting mechanism for transporting said web, said first transporting mechanism being arranged between said tension adding means and said printing unit;
a second transporting mechanism for transporting said web which has passed through said printing unit;
a third transporting mechanism arranged at a position downstream in the web transporting direction of said second transporting mechanism;
a buffer mechanism for absorbing slack or tension in the web due to difference between web transporting speeds of said second transporting mechanism and said third transporting mechanism, said buffer mechanism being arranged between said second transporting mechanism and said third transporting mechanism displaceably to a web transporting path;
an edge detection means for detecting an edge position in a width direction of said web;
a first control means for controlling an amount of web brought in by said bringing-in means based on an output of said slack amount detection means;
a second control means for controlling an amount of web transported by said third transporting mechanism based on displacement information of said buffer mechanism; and
a third control means for correct meandering of the web based on an output of said edge detection means.

4. A printer according to claim 3, which comprises an extraneous substance removing means for removing an extraneous substance attached onto surfaces of said web, said extraneous substance removing means being arranged between said guide means and said tension adding means.

5. A printer for forming an image on a transported web, which comprises:
a transfer means for transferring a toner image formed on an image holding body to said web;
an accumulation part for giving slack to said web, said accumulation part being arranged at a position upstream in a web transporting direction of said printing unit;
a web buffer means having a slack amount detection means for detecting an amount of slack of said web in said accumulation part and a bringing-in means for bringing said web into said accumulation part;
a tension adding means for adding a tension to said web, said tension adding means being arranged between said printing unit and said web buffer means;
a guide means for moving said web in a direction perpendicular to the web transporting direction before introducing said web into said tension adding means to correct a traveling position of said web;
a transporting roller mechanism for transporting said web while putting said web between rollers, said transporting roller mechanism being arranged between said tension adding means and said transfer means;
a transporting belt mechanism for transporting said web which has passed through said transfer means while holding a back surface of said web;
a fixing means having a pair of fixing rollers pressing to each other, said fixing means fixing the toner image transferred on said web to said web;
a buffer mechanism for absorbing slack or tension in the web due to difference between web transporting speeds of said transporting belt mechanism and said fixing means, said buffer mechanism being arranged between said transporting belt mechanism and said fixing means displaceably to a web transporting path;
an edge detection means for detecting an edge position in a width direction of said web;
a first control means for controlling an amount of web brought in by said bringing-in means based on an output of said slack amount detection means;
a second control means for controlling an amount of web transported by said fixing means based on displacement information of said buffer mechanism; and
a third control means for correct meandering of the web by adjusting a pressing force in an axial direction of said fixing roller based on an output of said edge detection means.

6. A printer according to claim 5, which comprises an extraneous substance removing means for removing an extraneous substance attached onto surfaces of said web, said extraneous substance removing means being arranged between said guide means and said tension adding means.

7. A printer for forming an image on a transported web without feeding perforations, which comprises:
a transfer means for transferring a toner image formed on an image holding body to said web;
an accumulation part for giving slack to said web, said accumulation part being arranged at a position upstream in a web transporting direction of said printing unit;
a web buffer means having a slack amount detection means for detecting an amount of slack of said web in said accumulation part and a bringing-in means for bringing said web into said accumulation part;
a tension adding means for adding a tension to said web, said tension adding means being arranged between said printing unit and said web buffer means;
a guide means for moving said web in a direction perpendicular to the web transporting direction before introducing said web into said tension adding means to correct a traveling position of said web;
a transporting roller mechanism for transporting said web while putting said web between rollers, said transporting roller mechanism being arranged between said tension adding means and said transfer means;
a transporting belt mechanism for transporting said web which has passed through said transfer means while holding a back surface of said web;
a fixing means having a pair of fixing rollers pressing to each other, said fixing means fixing the toner image transferred on said web to said web;
a buffer mechanism for absorbing slack or tension in the web due to difference between web transporting speeds of said transporting belt mechanism and said fixing means, said buffer mechanism being arranged between said transporting belt mechanism and said fixing means displaceably to a web transporting path;
an edge detection means for detecting an edge position in a width direction of said web;
a first control means for controlling an amount of web brought in by said bringing-in means based on an output of said slack amount detection means;
a second control means for controlling an amount of web transported by said fixing means based on displacement information of said buffer mechanism; and
a third control means for correct meandering of the web by adjusting a pressing force in an axial direction of said fixing roller based on an output of said edge detection means.

8. A printer according to claim 7, which comprises an extraneous substance removing means for removing an extraneous substance attached onto surfaces of said web, said extraneous substance removing means being arranged between said guide means and said tension adding means.
